(19) United States
(12) Patent Application Publication
(10) Pub. No.: US 2014/0186688 A1
(43) Pub. Date: Jul. 3, 2014

(54) SEALING MEMBER CAP, ELECTRIC STORAGE DEVICE, AND METHOD OF PRODUCING ELECTRIC STORAGE DEVICE

(71) Applicant: GS Yuasa International Ltd., Kyoto-shi (JP)

(72) Inventors: Shogo TSURUTA, Kyoto-shi (JP); Masamitsu TONONISHI, Kyoto-shi (JP); Ryutaro NISHIKAWA, Kyoto-shi (JP)

(73) Assignee: GS Yuasa International Ltd., Kyoto-shi (JP)

(21) Appl. No.: 14/137,667

(22) Filed: Dec. 20, 2013

(30) Foreign Application Priority Data
Dec. 28, 2012 (JP) 2012-287498
Nov. 21, 2013 (JP) 2013-240616

(51) Int. Cl. H01M 2/08

(52) U.S. Cl. CPC H01M 2/08
USPC 429/175; 29/623.2

(57) ABSTRACT

A sealing member cap, which is to be inserted into a through hole of a cell case of an electric storage device together with a sealing member, includes an insertion portion. The insertion portion has a column shape and includes a recess into which the sealing member is inserted. The insertion portion includes a body section and a large cross-section section. The body section is located in the through hole when the sealing member cap is inserted into the through hole. The large cross-section section is located inside the cell case when the sealing member cap is inserted into the through hole. The recess is larger in cross-sectional area in a plane perpendicular to an axial direction of the insertion portion at the large cross-section section than at the body section.

### CROSS-REFERENCE TO RELATED APPLICATIONS

This application claims priority from Japanese Patent Applications No. 2012-287498 filed on Dec. 28, 2012 and No. 2013-240616 filed on Nov. 21, 2013. The entire content of the priority applications is incorporated herein by reference.

### FIELD

The present invention relates to a technology for sealing a through hole of a cell case of an electric storage device.

### BACKGROUND

Conventionally, electric storage devices including secondary batteries are used. An electric storage device includes a cell case, which is made of metal such as aluminum, an electrode assembly, and electrolyte. The electrode assembly and the electrolyte are housed in the cell case (see JP-A-2003-132876, for example). The cell case includes an inlet hole through which the electrolyte is injected into the cell case. The inlet hole is sealed after the electrolyte is injected into the cell case. A well-known method of sealing the inlet hole is a method that uses a blind rivet to seal the inlet hole. According to the method, in order to improve the sealing of the inlet hole, a resin gasket is attached over an outer circumference of a sealing rivet and the inlet hole is sealed with such a sealing rivet with the gasket.

When a through hole such as an inlet hole, which is included in a cell case of an electric storage device to communicate with the inside and the outside of the cell case, is sealed by a sealing member cap such as gasket to which a sealing member such as a sealing rivet is attached, the sealing member is deformed and expanded outwardly in a radial direction, which is a direction perpendicular to an axial direction of the sealing member. With such a deformation, a stress is applied to the sealing member cap in a radially outward direction, and thus the sealing member cap is deformed. If the sealing member is deformed a lot, a lot of stress is applied to the sealing member cap. As a result, the sealing member cap may be damaged. In such a case, the through hole may not be air-tightly sealed.

This specification describes a technology for air-tightly sealing a through hole of a cell case.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

A sealing member cap described herein is a sealing member cap to be inserted into a through hole of a cell case of an electric storage device together with a sealing member. The sealing member cap includes an insertion portion having a column shape and including a recess into which the sealing member is inserted. The insertion portion includes a body section located in the through hole when the sealing member cap is inserted into the through hole, and a large cross-section section located inside the cell case when the sealing member cap is inserted into the through hole. The recess is larger in cross-sectional area in a plane perpendicular to an axial direction of the insertion portion at the large cross-section section than at the body section.

### BRIEF DESCRIPTION OF DRAWINGS

The foregoing and other features of the present invention will become apparent from the following description and drawings of an illustrative embodiment of the invention in which:

FIG. 1 is an exploded view of a cell;

FIG. 2 is a cross-sectional view of a rivet;

FIG. 3 is a cross-sectional view of a cap;

FIG. 4 is a flowchart of a sealing process;

FIG. 5 is a cross-sectional view of a cap during the sealing process;

FIG. 6 is a cross-sectional view of a sealing plug during the sealing process;

FIG. 7 is a cross-sectional view of the sealing plug after the sealing process;

FIG. 8 is a cross-sectional view of a sealing plug according to another embodiment; and

FIG. 9 is a cross-sectional view of a sealing plug according to another embodiment.

### DESCRIPTION OF EMBODIMENTS

Initially, an electric storage device of this embodiment will be briefly described.

A sealing member cap described herein is a sealing member cap to be inserted into a through hole of a cell case of an electric storage device together with a sealing member. The sealing member cap includes an insertion portion having a column shape and including a recess into which the sealing member is inserted. The insertion portion includes a body section located in the through hole when the sealing member cap is inserted into the through hole, and a large cross-section section located inside the cell case when the sealing member cap is inserted into the through hole. The recess is larger in cross-sectional area in a plane perpendicular to an axial direction of the insertion portion at the large cross-section section than at the body section.

In the sealing member cap, the insertion portion includes the large cross-section section and the cross-sectional area of the large cross-section section of the recess is larger than the cross-sectional area of the body section of the recess. In this configuration, when the sealing member that has the cross-sectional area substantially the same as that of the body section is inserted into the recess, a space is provided between the sealing member and the sealing cap at the large cross-section section. Accordingly, when the sealing member is deformed radially outwardly to seal the through hole, the deformed sealing member can be guided to the space, and thus the amount of deformation of the sealing member cap can be reduced compared to the case in which the above-described space is not provided. According to the sealing member cap, the damage of the sealing member cap can be reduced by reducing the amount of deformation of the sealing member cap that is caused by the deformation of the sealing member, and thus the through hole can be air-tightly sealed compared to the case in which the space is not provided.

In the above-described sealing member cap, the large cross-section section may protrude more outwardly than the body in a radial direction of the insertion portion.

According to the sealing member cap, the large cross-section section protrudes outwardly at the large cross-section section where the cross-sectional area thereof is larger than that of the body section, and thus, unlike the case in which the large cross-section section does not protrude outwardly, the cross-section section does not become thinner than the other sections of the insertion portion. Thus, the sealing member cap is less likely to be damaged at the large-cross section.

In the above-described sealing member cap, the cross-sectional area of the recess in the plane perpendicular to the axial direction of the insertion portion at the large cross-section section may be larger than a cross-sectional area of the through hole in a plane perpendicular to the axial direction of the insertion portion.

The sealing member generally expands outwardly of the through hole in a radial direction such that the cross-sectional area of the sealing member becomes larger than the cross-sectional area of the through hole, and thus the sealing member seals the through hole. In the sealing member cap, the cross-sectional area of the recess at the large cross-section section is made to be larger than the cross-sectional area of the thorough hole in advance, and thus the amount of deformation of the sealing member cap that is caused by the deformation of the sealing member can be reduced. As a result, the sealing member cap is less likely to be damaged.

In the above-described sealing member cap, the large cross-section section may be in contact with an inner surface of the cell case at a position adjacent to the through hole when the insertion portion is inserted into the through hole.

When the sealing member expands outwardly in the radial direction, the expansion of the sealing member at the body section of the recess is generally limited by the cell case, and thus the sealing member expands at a part of the insertion portion that is adjacent to the body section in the cell case. In the sealing member cap, the large cross-section section is provided at the part adjacent to the body section. Compared to the case in which the large cross-section section is located away from the body section, the sealing member is easily deformed to be in the space between the sealing member and the sealing cap at the large cross-section section. In addition, since the large cross-section section comes in contact with the inner surface of the cell case, the through hole is easily air-tightly sealed by the large cross-section section.

The above-described sealing member cap may further include a protrusion around the insertion portion. The protrusion may be in contact with an outer surface of the cell case when the insertion portion is inserted into the through hole.

In the sealing member cap, the sealing member cap includes the protrusion, and thus the entire sealing member cap is less likely to enter the cell case through the through hole. Further, the large cross-section section is in contact with the inner surface of the cell case when inserted into the through hole, and thus the sealing member cap is less likely to be slipped out of the through hole. According to the sealing member cap, the sealing member cap includes the large cross-section section and the protrusion, and thus the sealing member cap is fixed at the through hole in the axial direction of the insertion portion.

In the above-described sealing member cap, the protrusion may have a first contact surface that is in contact with the outer surface of the cell case and the first contact surface may include a first projection projecting from the first contact surface. According to the sealing member cap, the protrusion is pressed onto the outer surface of the cell case to deform the first projection, and thus the air tightness between the cell case and the sealing member cap can be maintained.

In the above-described sealing member cap, the protrusion may include a second contact surface that is in contact with a pressing portion of the sealing member. The pressing portion may be configured to press the protrusion toward the cell case when the sealing member is inserted into the recess. The second contact surface may include a second projection projecting from the second contact surface. According to the sealing member cap, the protrusion of the sealing member cap is pressed onto the outer surface of the cell case by the pressing portion of the sealing member to deform the second projection, and thus the air tightness between the sealing member cap and the sealing member can be maintained.

In the above-described sealing member cap, the insertion portion may have a bottom covering the recess. According to the sealing member cap, the air tightness between the sealing member cap and the sealing member can be maintained by the bottom of the insertion portion.

In the above-described sealing member cap, the sealing member may be a blind rivet. According to the sealing member cap, the through hole can be safely and easily sealed by the blind rivet compared to the other methods such as a laser welding method.

In the above-described sealing member, the sealing member cap may be a resin cap covering a front end of the blind rivet. According to the sealing member cap, the sealing member cap is made of the resin. The resin generally has a higher elasticity than a metal. Thus, the resin sealing member cap can air-tightly seal the through hole when inserted into the through hole. In addition, the resin is an insulating material, and thus a local cell is hardly generated between the sealing member cap and the cell case.

In the above-described sealing member cap, the sealing member cap may be made of a fluorine resin. The fluorine resin generally has a high heat resistance and a high strength, and further has a high resistance to the electrolyte. Accordingly, the sealing member cap is less likely to be damaged and the through hole is air-tightly sealed even when the electric storage device is heated or an impact is applied to the electric storage device. Further, a change in properties of the sealing member cap hardly occurs even when the electrolyte, which is to be injected into the electric device, is attached to the sealing member cap.

An electric storage device is also described herein. The electric storage device includes an electrode assembly, a cell case having a housing space housing the electrode assembly and a through hole communicating with the housing space and an outside of the cell case, a sealing member, and the above-described sealing member cap.

A method of producing an electric storage device is also described herein. The electric storage device includes a cell case having a through hole, a sealing member inserted in the through hole and sealing the through hole, and a sealing member cap having a column shape and including an insertion portion having a recess therein. The insertion portion includes a body section and a large cross-section section. The recess is larger in cross-sectional area in a plane perpendicular to an axial direction of the insertion portion at the large cross-section section than at the body section. The method includes inserting the insertion portion into the through hole such that the body section is positioned in the through hole and the large cross-section section is positioned inside the cell case, whereby the through hole is temporary sealed, inserting the sealing member into the recess of the insertion portion after the through hole is temporary sealed and deforming the sealing member to seal the through hole.

The electric storage device produced by the method includes the large cross-section section in the insertion portion of the sealing member cap. The recess is larger in cross-sectional area at the large cross-section section than at the body section. Accordingly, in the production of the electric storage device, when the sealing member having a cross-sectional area same as the cross-sectional area of the body section of the recess is inserted into the recess, a space is provided between the sealing member and the sealing member cap at the large cross-section section. In this configuration, when the sealing member is deformed to seal the through hole, the deformed sealing member enters the space and presses the large cross-section section to seal the through hole. According to the production method of the electric storage device, the deformation of the sealing member cap by the deformed sealing member is reduced, and thus the sealing member cap is less likely to be damaged. Compared to the case in which the sealing member cap includes no large cross-section section, the through hole is air-tightly sealed in this configuration.

According to the invention described herein, the thorough hole of the cell case is air-tightly sealed.

### Embodiments

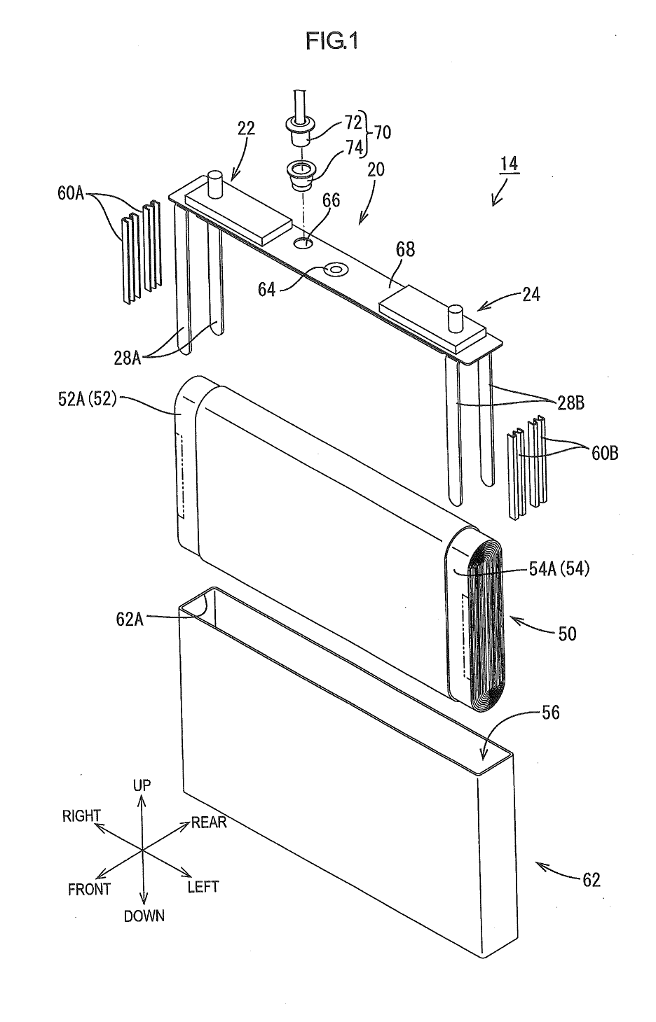

A first embodiment will be described with reference to FIG. 1 to FIG. 7.

1. Configuration of a Cell

A cell 14 (see FIG. 1) of this embodiment is a secondary battery that can be repeatedly charged and discharged, more specifically, a lithium-ion battery. A plurality of cells 14 of this embodiment may be connected by a bus bar, which is a plate-shaped member having conductivity, and installed in an electric vehicle or a hybrid vehicle for supplying power to a power source that can be activated by electric energy. The cell 14 may be an example of an electric storage device.

As illustrated in FIG. 1, the cell 14 includes a terminal unit 20, an electrode assembly 50, clips 60A, 60B, a case 62, and a hole plug 70. Hereinafter, for ease of explanation, the cell 14 is described with the vertical direction in FIG. 1 as an up-down direction of the cell 14, a direction perpendicular to a side surface having a larger area among side surfaces of the case 62 as a front-rear direction of the cell 14, and a direction perpendicular to a side surface having a smaller area among the side surfaces of the case 62 as a right-left direction of the cell 10.

The case 62 is made of metal such as aluminum. The case 62 has a cuboidal shape that has an open top. The case 62 has a housing space 56 that houses the flat-shaped electrode assembly 50 and the housing space 56 is filled with electrolyte. A top end opening 62A of the case 62, which communicates with the housing space 56, is closed by a lid 68 that is a rectangular plate included in the terminal unit 20. The case 62 with the lid 68 may be an example of a cell case.

In the terminal unit 20, a positive terminal 22 and a negative terminal 24 are arranged away from each other in the right-left direction on an upper surface of the lid 68. Pairs of current collectors 28A and 28B that are connected to the electrode terminals 22, 24, respectively, extend downward from a lower surface of the lid 68. Each current collector 28A, 28B is a metal plate having a sufficient thickness to have a large current capacity. The positive current collectors 28A are aluminum alloy plates, for example. The negative current collectors 28B are copper alloy plates, for example.

The electrode assembly 50 includes a positive electrode 52, a negative electrode 54, and a separator (not illustrated). The electrode assembly 50 is configured such that the positive electrode 52 and the negative electrode 54 are wound in a flat cylindrical shape with the separator arranged therebetween. In unwound states, the positive electrode 52 and the negative electrode 54 have a tape-like shape with the longitudinal direction thereof being a direction in which they are wound. The positive electrode 52 includes a tape-like shaped aluminum foil and a positive active material layer formed on a surface of the aluminum foil. A portion of the positive electrode 52 at one edge that extends in a direction perpendicular to the longitudinal direction thereof (i.e., a short side on a right edge) is a positive current collector foil potion 52A in which the positive active material layer is not formed on the surface of the aluminum foil, that is, a bare aluminum foil is provided. The negative electrode 54 includes a tape-like shaped copper foil and a negative active material layer formed on a surface of the copper foil. A portion of the negative electrode 54 at the other edge that extends in a direction perpendicular to the longitudinal direction thereof is a negative current collector foil portion 54A in which the negative active material layer is not formed, that is, a bare copper foil is provided.

The positive current collector foil portion 52A is located at the right of the electrode assembly 50 and connected to the positive current collector 28A at a side surface portion indicated by a two-dotted chain line in FIG. 1. The negative current collector foil portion 54A is located at the left of the electrode assembly 50 and connected to the negative current collector 28B at a side surface portion indicated by a two dotted chain line in FIG. 1.

The positive current collector 28A and the positive current collector foil portion 52A are sandwiched between the positive clips 60A and welded together by ultrasonic welding. The negative current collector 28B and the negative current collector foil portion 54A are sandwiched between the negative clips 60B and welded together by ultrasonic welding. Each clip 60A, 60B is made of material having the resistance substantially the same as that of the current collectors 28A, 28B or the current collector foil portions 52A, 54A. The positive clips 60A may be made of aluminum alloy. The negative clips 60B may be made of copper alloy.

The electrode assembly 50 is housed in the case 62 after connected to the current collectors 28A, 28B. The case 62 and the lid 68 are welded together and thus the electrode assembly 50 is sealed in the case 62. The lid 68 has an inlet hole 66 having a cylindrical shape at a middle of the lid 68. Through the inlet hole 66, the electrolyte is injected into the case 62. The housing space 56 inside the case 62 communicates with an exterior space outside the cell 14 through the inlet hole 66. In a production process of the cell 14, the electrolyte is injected into the case 62 through the inlet hole 66 after the electrode assembly 50 is sealed in the case 62, and then the inlet hole 66 is sealed by a hole plug 70. A safety valve 64 is arranged in the middle of the lid 68. The safety valve 64 is a non-restorable type safety valve for releasing internal gas inside the case 62 if an internal pressure of the case 62 becomes equal to or higher than a predetermined level. The inlet hole 66 may be an example of a through hole.

2. Configuration of the Hole Plug

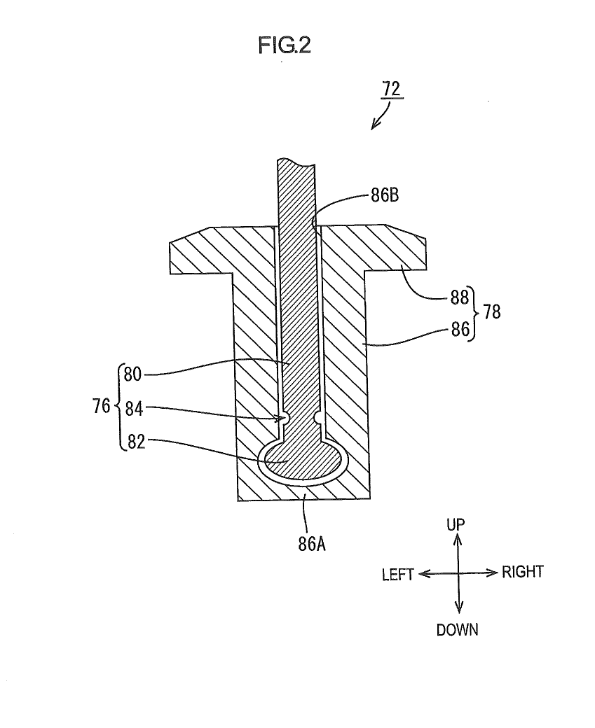

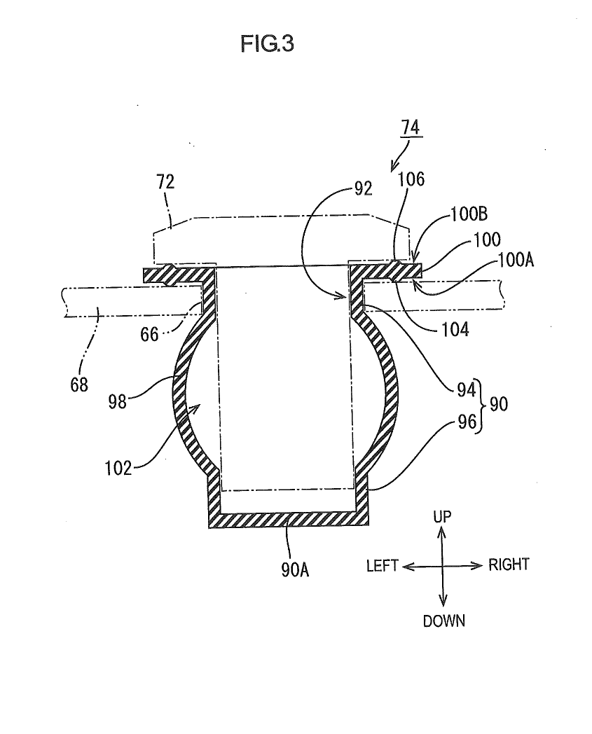

The hole plug 70 includes a blind rivet (hereinafter, a rivet) 72 (see FIG. 2) and a resin cap (hereinafter, a cap) 74 having a bottom (see FIG. 3). The rivet 72 includes a mandrel 76 made of metal and a sealing body 78 made of metal. The rivet 72 and the cap 74 are inserted into the inlet hole 66 to seal the inlet hole 66. The rivet 72 may be an example of a sealing member. The cap 74 may be an example of a sealing member cap.

(Configuration of the Rivet)

As illustrated in FIG. 2, the mandrel 76 includes a shaft 80 having a cylindrical shape and a large diameter portion 82 having a flattened spherical shape. The large diameter portion 82 is located at a lower end of the shaft 80 and has a larger diameter in a plane perpendicular to an axial direction (i.e., in the vertical direction) of the shaft 80 than the shaft 80. In other words, the large diameter portion 82 has a larger dimension than the shaft 80 in at least one direction that is perpendicular to the axial direction of the shaft 80. At a boundary between the shaft 80 and the large diameter portion 82 of the mandrel 76, a fragile portion 84 is provided. The fragile portion 84 has a smaller diameter than the shaft 80 and is more fragile than the shaft 80. A diameter, an outer diameter, and an inner diameter, which will be referred in the following description, correspond to a diameter, an outer diameter, and an inner diameter in a direction perpendicular to the axial direction (a depth direction).

The sealing body 78 is made of metal that is softer than the mandrel 76. The sealing body 78 covers the lower end of the shaft 80 at which the large diameter portion 82 is provided. The sealing body 78 includes a tubular portion 86 that has a bottom and a flange 88 that has a disk-like shape. The tubular portion 86 has a length in an axial direction thereof larger than a thickness of the lid 68. The tubular portion 86 has a bottom 86A at a lower end thereof that covers a lower surface of the large diameter portion 82 of the mandrel 76. The flange 88 is provided around an upper end of the tubular portion 86. The flange 88 has a larger outer diameter than the tubular portion 86, and further than the inlet hole 66 of the lid 68. The flange 88 may be an example of a pressing portion.

The tubular portion 86 includes an housing hole 86B that houses the lower end portion of the mandrel 76. A portion of the housing hole 86B that covers the shaft 80 has an inner diameter that is substantially the same as the diameter of the shaft 80. A portion of the housing hole 86B that covers the large diameter portion 82 has an inner diameter that is substantially the same as the diameter of the large diameter portion 82. The inner diameter of the housing hole 86B is enlarged at the portion that covers the large diameter portion 82. In the tubular portion 86, the housing hole 86B has a smaller inner diameter at the portion covering the shaft 80 than the portion covering the large diameter portion 82, and the tubular portion 86 includes the bottom 86A at the lower end. With this configuration, the mandrel 76 is unmovably fixed to the sealing body 78.

(Configuration of the Cap)

As illustrated in FIG. 3, the cap 74 includes an insertion portion 90 having a column shape and a protrusion 100 having a disk-like shape. The cap 74 may be made of a fluorine resin such as tetrafluoroethylene/perfluoro alkyl vinyl ether copolymer (PFA), polytetrafluoroethylene (PTFE), and PFA modified PTFE. The insertion potion 90 is a cylindrical tube having a bottom. The insertion portion 90 has a uniform thickness and inner and outer diameters thereof continuously change in an axial direction thereof (i.e., in the vertical direction). The insertion portion 90 includes a recess 92 that is configured to house the lower end portion of the rivet 72. The insertion portion 90 includes a bottom 90A at its lower end. The bottom 90A air-tightly covers the lower end of the insertion portion 90 such that the lower end of the insertion portion 90 is sealed. The protrusion 100 extends radially outwardly from the upper end of the insertion portion 90 over the entire circumference thereof

The insertion portion 90 is larger in an axial direction thereof than the thickness of the lid 68. The insertion portion 90 includes a body section 94, which is located close to the protrusion 100, and an introduction section 96. The body section 94 and the introduction section 96 have a concentric cylindrical tube shape. A recess 92 is provided over the body section 94 and the introduction section 96. The recess 92 is larger in a depth direction thereof (i.e., in the vertical direction) than the thickness of the lid 68.

The body section 94 of the insertion portion 90 is located in the inlet hole 66 when the insertion portion 90 is inserted into the inlet hole 66. The body section 94 has a length in the axial direction of the insertion portion 90 substantially the same as the thickness of the lid 68. The body section 94 has an outer diameter that is substantially the same as an inner diameter of the inlet hole 66. The body section 94 has an inner diameter that is substantially the same as an outer diameter of the tubular portion 86 of the sealing body 78.

The introduction section 96 of the insertion portion 90 is located inside the case 62 when the insertion portion 90 is inserted into the inlet hole 66. The introduction section 96 includes a large diameter section 98 at a position adjacent to the body section 94. The large diameter section 98 has a larger diameter than the body section 94 and protrudes outwardly over the entire circumference of the insertion portion 90. The large diameter section 94 has an outer diameter larger than the outer diameter of the body section 94, i.e., the inner diameter of the inlet hole 66. In other words, a dimension of the large diameter section 98 in at least one direction perpendicular to the axial direction (i.e., the vertical direction) is larger than a dimension of the body section 94 in the at least one direction. The large diameter section 98 has a spherical outer shape. A diameter of the large diameter section 98, which is a dimension in the direction perpendicular to the axial direction, gradually increases from an upper side thereof that is adjacent to the body section 94 and then gradually decreases to a lower side thereof. The large diameter section 98 may be an example of a large cross-section section.

At the large diameter section 98, the recess 92 is larger in a radial direction of the insertion portion 90 than at the body 94, and thus the larger diameter section 98 has an inner diameter larger than that of the body section 94, i.e., larger than the outer diameter of the tubular potion 86 of the sealing portion 78. In other words, the recess 92 is larger in cross-sectional area in a plane perpendicular to the depth direction of the recess 92 at the large diameter section 98 than at the body section 94. The recess 92 has a larger dimension in at least one direction perpendicular to the depth direction at the large diameter section 98 than at the body section 94. In this configuration, as illustrated by a one-dotted chain line in FIG. 3, a space 102 is provided between the large diameter section 98 and the rivet 72 when the rivet 72 is inserted into the recess 92 of the insertion portion 90 to seal the inlet hole 66 by the hole plug 70. In this embodiment, the large diameter section 98 has the inner diameter larger than the outer diameter of the body section 94, i.e., larger than the inner diameter of the inlet hole 66. The larger diameter section 98 of the recess 92 has the larger cross-sectional area than the inlet hole 66. In other words, the recess 92 has the larger dimension in at least one direction perpendicular to the depth direction of the recess 92 than the inlet hole 66.

Next, the protrusion 100 will be explained.

The protrusion 100 has a larger outer diameter than the inlet hole 66 of the lid 68. As illustrated by a two-dotted chain line in FIG. 3, when the cap 74 is inserted into the inlet hole 66 to seal the inlet hole 66 by the hole plug 70, a lower surface 100A of the protrusion 100 is in contact with an outer surface of the lid 68 at a periphery of the inlet hole 66. The protrusion 100 includes a lower projection 104 that projects downwardly from the lower surface 100A. The lower projection 104 has a ring-like shape extending over the entire circumference of the recess 92. When the inlet hole 66 is sealed, the lower projection 104 comes in contact with the outer surface of the lid 68 before any other parts of the lower surface 100A. The lower surface 100A may be an example of a first contact surface. The lower projection 104 may be an example of a first projection.

As illustrated by the one-dotted chain line in FIG. 3, when the rivet 72 is inserted into the recess 92 of the insertion portion 90 to seal the inlet hole 66 by the hole plug 66, an upper surface 100B of the protrusion 100 comes in contact with the flange 88 of the sealing body 78. The protrusion 100 includes an upper projection 106 that projects upwardly from the upper surface 100B at a part to be in contact with the flange 88. The upper projection 106 has a ring-like shape extending over the entire circumference of the recess 92. When the inlet hole 66 is sealed, the upper projection 106 comes in contact with the flange 88 before any other parts of the upper surface 100B. The upper surface 100B may be an example of a second contact surface. The upper projection 106 may be an example of a second projection.

The upper projection 106 and the lower projection 104 are located at corresponding positions on the upper surface 100B and the lower surface 100A of the protrusion 100. The upper projection 106 is located at a position overlapped with the lower projection 104 if the upper projection 106 is moved in the vertical direction. In other words, the lower projection 104 is positioned directly below the upper projection 106.

3. Sealing Process

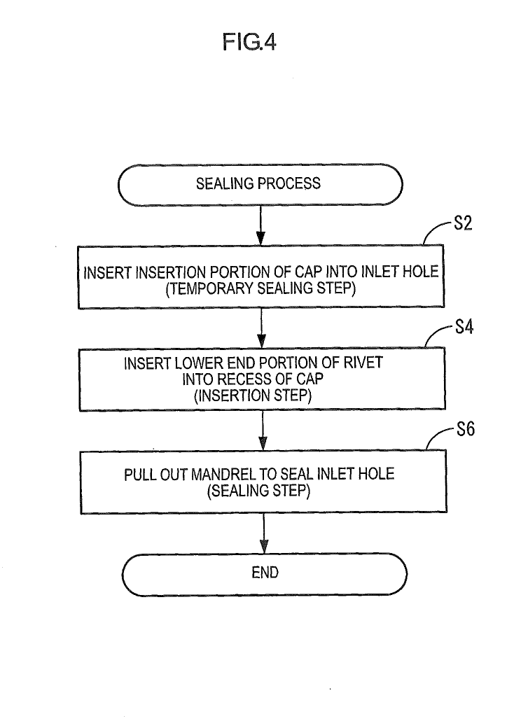

Next, a sealing process of the inlet hole 66 in the production of the cell 14 will be explained with reference to FIG. 4 to FIG. 6. A flowchart of the sealing process is illustrated in FIG. 4. The sealing process is performed by a production apparatus, which is not illustrated. In the following explanation, a process that is explained with the production apparatus as the subject may be performed by a manufacturer of the cell 14 instead of the production apparatus.

The production apparatus starts the sealing process after that the electrode assembly 50, which is connected to the terminal unit 20 by the clips 60A, 60B, is housed in the case 62 and the electrolyte is injected into the case 62 through the inlet hole 66. The production apparatus inserts the insertion portion 90 of the cap 74 into the inlet hole 66 (S2) at the beginning of the sealing process. At this time, the rivet 72 is not inserted in the recess 92 of the cap 74.

The insertion portion 90 includes the large diameter section 98 that has a larger diameter than the inlet hole 66. However, the insertion portion 90 includes the recess 92, and the metal rivet 72 is not inserted in the recess 92 of the insertion portion 90 when the insertion portion 90 is inserted into the inlet hole 66. Accordingly, when the insertion portion 90 is inserted into the inlet hole 66, the large diameter section 98 of the resin insertion portion 90 can change its shape toward the inside of the recess 92 due to its elasticity.

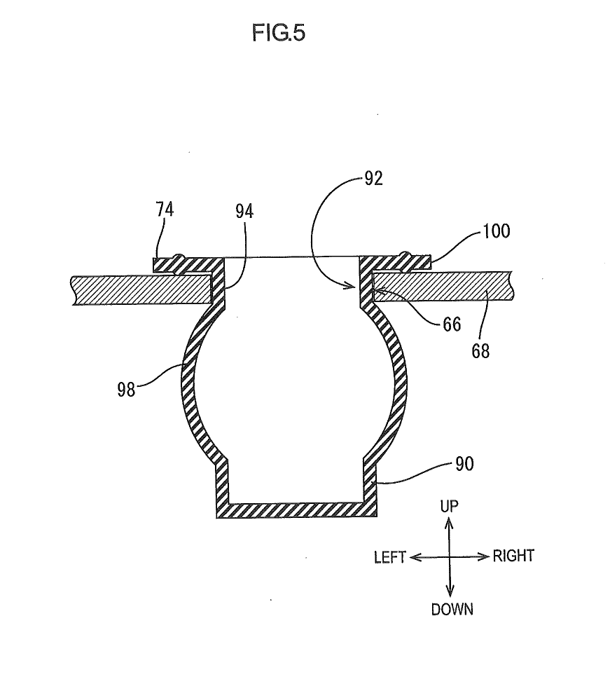

The large diameter section 98 of the insertion portion 90 is inserted into the case 62 and expands its diameter to be larger than the inner diameter of the inlet hole 66. In this configuration, as illustrated in FIG. 5, the large diameter section 98 is in contact with the inner surface of the lid 68 at the periphery of the inlet hole 66 over the entire circumference thereof. When the insertion portion 90 is inserted into the inlet hole 66, the protrusion 100 of the cap 74 comes in contact with the outer surface of the lid 68 at the periphery of the inlet hole 66. Accordingly, when the insertion portion 90 is inserted into the inlet hole 66, the cap 74 is positioned relative to the lid 68 by the large diameter section 98 and the protrusion 100 of the cap 74, and thus the cap 74 is hardly moved relative to the lid 68 in the depth direction of the inlet hole 66 (i.e., the vertical direction). This temporally seals the inlet hole 66.

After the process in step S2, the cap 74 is removal from the inlet hole 66 due to the elasticity of the resin cap 74. Thus, if the entire of the large diameter section 98 of the insertion portion 90 is not passed through the inlet hole 66 and the cap 74 is not positioned relative to the lid 68, the insertion portion 90 may be removed from the inlet hole 66 and may be inserted into the inlet hole 66 again.

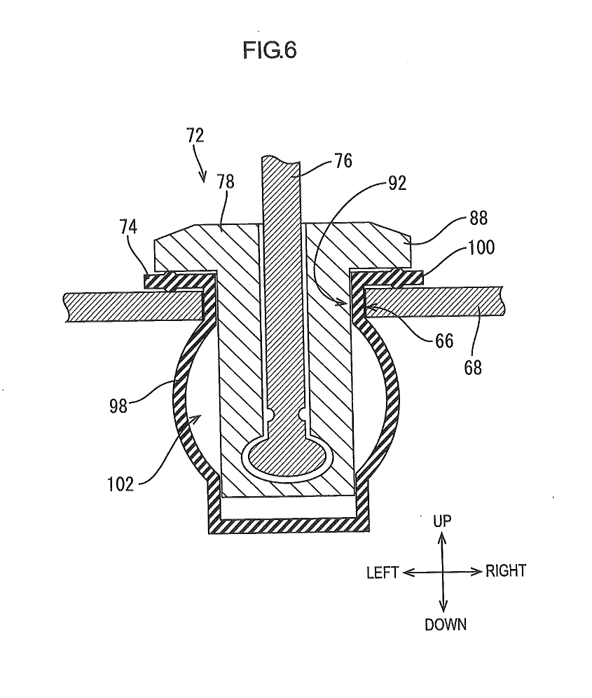

Next, the production apparatus inserts a lower end portion of the rivet 72 into the recess 92 of the cap 74 that is inserted in the inlet hole 66 (S4). Accordingly, the lower end portion of the rivet 72 is inserted into the inlet hole 66 with the cap 74 therebetween, and the flange 88 of the sealing body 78 comes in contact with the protrusion 100 of the cap 74 and stops at the protrusion 100. In this state, the lower end portion of the rivet 72 is covered by the cap 74. As a result, as illustrated in FIG. 6, a space 102 is provided between the large diameter section 98 of the cap 74 and the rivet 72 with the rivet 72 inserted in the recess 92 of the cap 74.

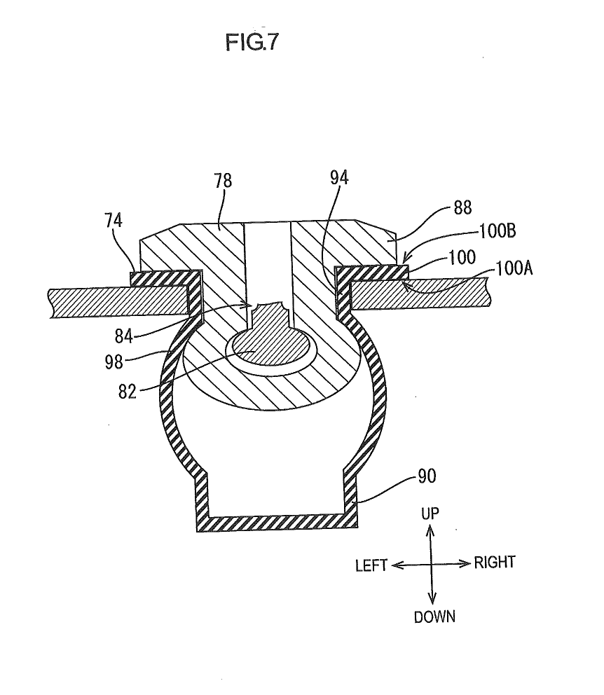

Lastly, the production apparatus pulls out the mandrel 76 (see FIG. 6) with the flange 88 of the sealing body 78 pressed toward the lid 68 (S6). This is the end of the sealing process. Since stress is applied to the sealing body 78, which is made of softer metal than the mandrel 76, in a radial direction (i.e., the right-left direction and the front-rear direction), the sealing body 78 is deformed. As illustrated in FIG. 7, the sealing body 78 that is enlarged in a radial direction by the deformation enters the space 102 provided between the large diameter section 98 of the cap 74 and the sealing body 78. The sealing body 78 comes in contact with an inner surface of the large diameter section 98 and presses the large diameter section 98 outwardly. As a result, a portion of the large diameter section 98 of the cap 74 that is adjacent to the lid 68 is pressed toward the inner surface of the lid 68, and thus the sealing body 78 is press-fitted to the inlet hole 66 with the large diameter section 98 of the cap 74 therebetween.

In addition, a stress is applied to the sealing body 78 downwardly, i.e. toward the large diameter portion 82 of the mandrel 76, and thus the fragile portion 84 of the mandrel 76 is broken. As a result, the maximum outer diameter of the tubular portion 86 of the sealing body 78 is maintained at a value larger than the inner diameter of the body section 94 of the insertion portion 90, and thus the inlet hole 66 is sealed.

The flange 88 of the sealing body 78 is pressed toward the lid 68 when the mandrel 76 is pulled out, and thus the lower projection 104 on the lower surface 100A of the protrusion 100 of the cap 74 is deformed and crushed flatly. As a result, the air tightness between the protrusion 100 of the cap 74 and the outer surface of the lid 68 is maintained. In addition, the upper projection 106 on the upper surface 100B of the cap 74 is deformed and crushed flatly. As a result, the air tightness between the protrusion 100 of the cap 74 and the flange 88 of the sealing body 78 is maintained.

4. Effects

(1) In the cell 14 of this embodiment, the introduction section 96 of the cap 74 includes the large diameter section 98 that has a larger diameter than the body section 94, i.e., the recess 92 is larger in cross-sectional area at the large diameter section 98 than at the body section 94. When the rivet 72 is inserted into the recess 92 of the cap 74, the space 102 is provided between the large diameter section 98 and the rivet 72. In this configuration, when the sealing body 78 of the rivet 72 is deformed, the sealing body 78 that has the enlarged diameter due to the deformation enters the space 102, and thus the introduction section 96 of the cap 74 that includes the large diameter section 98 is less likely to be deformed and enlarged outwardly in the radial direction. In this configuration, when the inlet hole 66 is sealed, the case in which the inlet hole 66 is not air-tightly sealed due to the deformation of the introduction section 96, which results in the damage of the cap 74, is less likely to occur.

(2) The larger the inner diameter of the large diameter section 98, i.e., the larger the cross-sectional area of the recess 92 at the large diameter section 98, the larger the effect of reducing the above-described deformation of the large diameter section 98. In the cell 14 of this embodiment, the large diameter section 98 has the inner diameter larger than that of the inlet hole 66. In this configuration, the inner diameter of the large diameter section 98 is not required to be enlarged to have a larger cross-sectional area of the recess 92 at the large diameter section 98 in order to seal the inlet hole 66 by the rivet 72, and the cap 74 is less likely to be damaged by the deformation of the introduction section 96.

(3) In the cell 14 of this embodiment, the large diameter section 98 protrudes more outwardly in the radial direction than the body section 94, i.e., the large diameter section 98 has a larger diameter than the body section 94. The large diameter section 98 has the same thickness as the body section 94. In other words, the large diameter section 98 is not made thinner than the other sections of the introduction section 96, and thus the introduction section 96 is less likely to be damaged at the large diameter section 98.

(4) In the cell 14 of this embodiment, the large diameter section 98 of the introduction section 96 is adjacent to the body section 94. The body section 94 does not expand outwardly in the radial direction when the sealing body 78 of the rivet 72 is deformed and expanded, because the body section 94 is surrounded by the lid 68. In this configuration, the sealing body 78 tends to expand at a part adjacent to the body section 94. In the cell 14 of this embodiment, the large diameter section 98 is provided at the part adjacent to the body section 94, and thus the sealing body 78 is easily deformed into the space 102 between the large diameter section 98 and the rivet 72.

(5) As described above, the large diameter section 98 protrudes more outwardly in the radial direction than the body section 94 and the large diameter section 98 is adjacent to the body section 94. In this configuration, when the introduction section 96 of the cap 74 is inserted into the inlet hole 66, the large diameter section 98 comes in contact with the inner surface of the lid 68 and covers a periphery of the inlet hole 66. Accordingly, in the cell 14 of this embodiment, the inlet hole 66 is easily air-tightly sealed by the cap 74 before the rivet 72 is inserted into the recess 92 of the cap 74.

(6) In the cell 14 of this embodiment, the introduction section 96 of the cap 74 includes the large diameter section 98 and the cap 74 includes the protrusion 100 that protrudes more outwardly in the radial direction (i.e., the right-left direction and the front-rear direction) than the body section 94. When the introduction section 96 of the cap 74 is inserted into the inlet hole 66, the large diameter section 98 comes in contact with the inner surface of the lid 68 and the protrusion 100 comes in contact with the outer surface of the lid 68. Accordingly, the cap 74 is positioned relative to the lid 68 in the axial direction of the introduction section 96 by the large diameter section 98 and the protrusion 100 when the introduction section 96 of the cap 74 is inserted into the inlet hole 66, and thus the inlet hole 66 can be easily air-tightly sealed.

(7) In the cell 14 of this embodiment, the lower projection 104 is provided on the lower surface 100A of the protrusion 100. The lower projection 104 serve as a packing for sealing the inlet hole 66, and thus the air-tightness between the protrusion 100 and the outer surface of the lid 68 can be maintained. Further, the upper projection 106 is provided on the upper surface 100B of the protrusion 100. The upper projection 106 serves as a packing for sealing the inlet hole 66, and thus the air-tightness between the protrusion 100 and the flange 88 of the sealing body 78 can be maintained.

(8) In the cell 14 of this embodiment, the cap 74 is made of a fluorine resin. In this configuration, the cap 74 is less likely to be damaged and the inlet hole 66 can be air-tightly sealed even when the cell 14 is heated due to the charge and the discharge, or even when an impact is applied to the cell 14 by sudden acceleration or sudden stop of an electric vehicle in which the cell 14 is mounted, or even when the electrolyte is attached to the cap 74 due to splash of the electrolyte in the cell 14.

### Other Embodiments

The present invention is not limited to the embodiment described above and illustrated in the drawings. The following various embodiments are also included in the technical scope of the present invention.

(1) In the above embodiments, the cell 14, which is a secondary battery, is described as an example of the electric storage device. However, the electric storage device may be a capacitor in which electrochemical reactions occur. The application of the electric storage device and the configuration of the electrode unit are not limited to the above embodiments.

(2) In the above embodiments, the rivet 72 is inserted into the inlet hole 66 together with the cap 74 to seal the inlet hole 66. However, any other rivet than the blind rivet or a sealing member other than the rivet may seal the inlet hole 66. Any sealing member may be used as long as the sealing member can be deformed and expanded in the recess 92 of the cap 74 and can enter the space 102 provided between the cap 74 and the sealing member to seal the inlet hole 66.

(3) The cap 74 may not be made of resin. However, if the cap 74 is made of an insulating material such as resin, a local cell hardly occurs between the metal lid 68 and the resin cap 74. As a result, the electric storage device is less likely to be deteriorated.

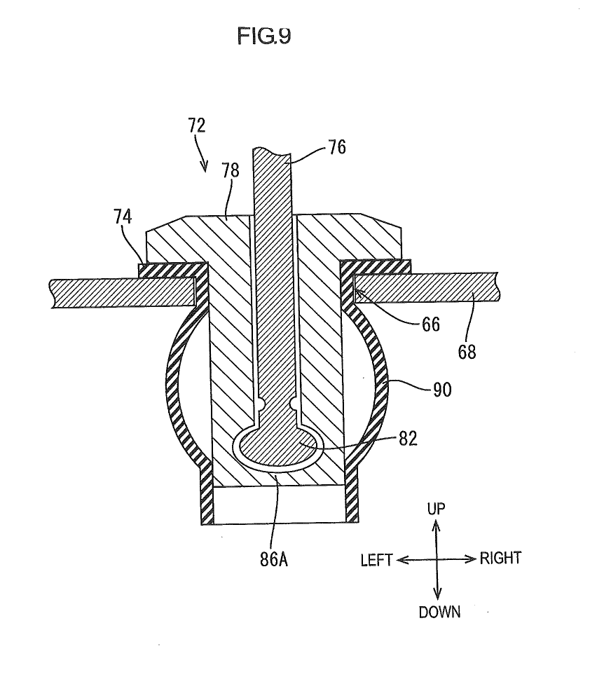

(4) The cap 74 may not have the bottom. As illustrated in FIG. 9, if the cap 74 does not have a bottom, the rivet 72 is preferably a sealed type rivet as the above-described embodiment. In the sealed type rivet, the sealing body 78 of the rivet 72 has a bottom 86A that covers the lower surface of the large diameter portion 82 of the mandrel 76. In this configuration, even when a space between the metal sealing body 78 and the mandrel 76 is not air-tightly sealed, the inlet hole 66 can be air-tightly sealed by the bottom 86A of the sealing body 78.

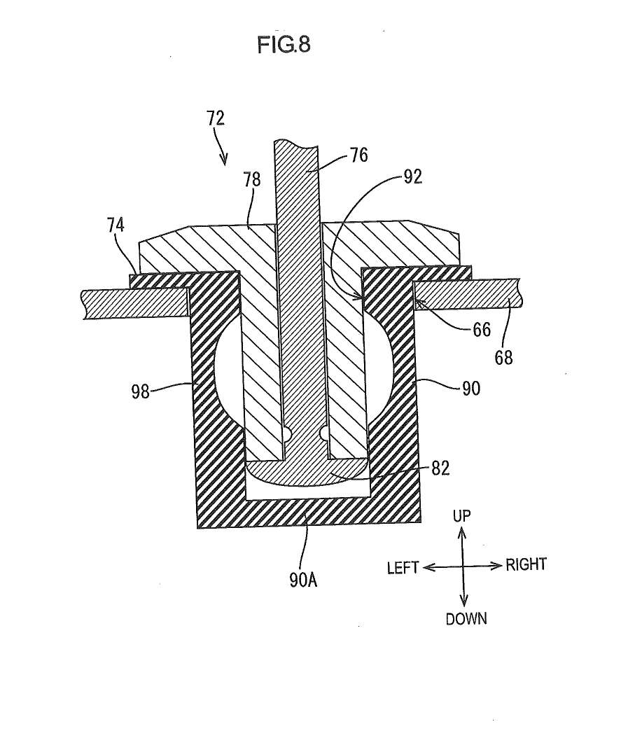

(5) As illustrated in FIG. 8, if the cap 74 has a bottom 90A, the rivet 72 may be an open-type rivet. In the open-type rivet, the sealing body 78 of the rivet 72 has no bottom and the lower surface of the large diameter portion 82 of the mandrel 76 is not covered by the sealing body 78 of the rivet 72. In such a case, when a space between the metal sealing body 78 and the mandrel 76 is not air-tightly sealed, the inlet hole 66 can be air-tightly sealed by the bottom 90A of the cap 74.

(6) In the above embodiment, the protrusion 100 of the cap 74 includes the lower projection 104 and the upper projection 106. However, as illustrated in FIG. 8 and FIG. 9, if the entire of the lower surface 100A of the protrusion 100 and the entire of the upper surface 100B of the protrusion 100 serve as the packing, the lower projection 104 and the upper projection 106 may not be provided. If the protrusion 100 includes the lower projection 104 and the upper projection 106, it can be determined whether the air tightness between the projection 100 of the cap 74 and the flange 88 of the sealing body 78 is maintained by checking whether the lower projection 104 and the upper projection 106 are crushed flatly after the inlet hole 66 is sealed.

(7) The cap 74 may not include the protrusion 100. If the cap 74 is positioned relative to the sealing body 78 by the insertion portion 90 of the cap 74 and the inlet hole 66 is air-tightly sealed, the cap 74 may not include the protrusion 100.

(8) In the above embodiments, the large diameter section 98 is adjacent to the body section 94 of the insertion potion 90 of the cap 74. However, the large diameter section 98 may be located away from the body section 94 and may be located at any position of the insertion portion 90 as long as the expanded portion of the rivet 72, which is defaulted and expanded, enters the space 102 between the cap 74 and the large diameter portion 98 to seal the valve 66.

(9) In the above embodiments, the large diameter section 98 has the larger inner diameter than the inlet hole 66. However, since the larger diameter section 98 that has the larger inner diameter than the body section 94 can reduce the damage caused by the deformation of the introduction section 96, the large diameter section 98 may not have the larger inner diameter than the inlet hole 66.

(10) The large diameter section 98 may not protrude outwardly in the radial direction. As illustrated in FIG. 8, the insertion portion 90 of the cap 74 may have varied inner diameter and thickness in the axial direction thereof and a uniform outer diameter in the axial direction thereof. In such a case, the large diameter section 98 is thinner than the other sections of the insertion portion 90. The large diameter section 98 is less likely to be damaged as long as the large diameter section 98 has a thickness larger than a certain thickness. Then, the expanded portion of the rivet 72, which is deformed and enlarged, enters the space 102 provided between the cap 74 and the large diameter portion 98 with the rivet 72 inserted into the recess 92 of the cap 74, and the large diameter section 98, which is easily deformed compared to the other sections 98 of the insertion portion 90, is expanded outwardly only slightly in the radial direction. This can seal the inlet hole 66.

(11) In the above embodiment, the inlet hole 66, the rivet 72, and the cap 74 each have a circular cross section in a plane perpendicular to the axial direction. However, the cross section may not be the circular cross section. The cross section may be a polygonal cross section such as a square cross section and a rectangular cross section. In such a case, the term “large diameter” described above may be interpreted as “large cross-section” that has the enlarged cross-sectional area.

(12) In the above embodiment, the rivet 72 and the cap 74 constitute the hole plug 70 that is configured to seal the inlet hole 66. However, a thorough hole that is to be sealed by the rivet 72 and the cap 74 is not limited to the inlet hole 66. For example, the rivet 72 and the cap 74 may constitute the safety valve 64 and seal a thorough hole to which the safety valve 64 is attached.

1. A sealing member cap to be inserted into a through hole of a cell case of an electric storage device together with a sealing member, the sealing member cap comprising:
an insertion portion having a column shape and including a recess into which the sealing member is inserted, the insertion portion includes:
a body section located in the through hole when the sealing member cap is inserted into the through hole; and
a large cross-section section located inside the cell case when the sealing member cap is inserted into the through hole, wherein
the recess is larger in cross-sectional area in a plane perpendicular to an axial direction of the insertion portion at the large cross-section section than at the body section.

2. The sealing member cap according to claim 1, wherein the large cross-section section protrudes more outwardly than the body in a radial direction of the insertion portion.

3. The sealing member cap according to claim 2, wherein the cross-sectional area of the recess in the plane perpendicular to the axial direction of the insertion portion at the large cross-section section is larger than a cross-sectional area of the through hole in a plane perpendicular to the axial direction of the insertion portion.

4. The sealing member cap according to claim 2, wherein the large cross-section section is in contact with an inner surface of the cell case at a position adjacent to the through hole when the insertion portion is inserted into the through hole.

5. The sealing member cap according to claim 4, further comprising a protrusion around the insertion portion, the protrusion being in contact with an outer surface of the cell case when the insertion portion is inserted into the through hole.

6. The sealing member cap according to claim 5, wherein
the protrusion has a first contact surface that is in contact with the outer surface of the cell case, and
the first contact surface includes a first projection projecting from the first contact surface.

7. The sealing member cap according to claim 5, wherein
the protrusion has a second contact surface that is in contact with a pressing portion of the sealing member, the pressing portion being configured to press the protrusion toward the cell case when the sealing member is inserted into the recess, and
the second contact surface includes a second projection projecting from the second contact surface.

8. The sealing member cap according to claim 1, wherein the insertion portion has a bottom covering the recess.

9. The sealing member cap according to claim 1, wherein the sealing member is a blind rivet.

10. The sealing member cap according to claim 9, wherein the sealing member cap is a resin cap covering a front end of the blind rivet.

11. The sealing member cap according to claim 1, wherein the sealing member cap is made of a fluorine resin.

12. An electric storage device comprising:
an electrode assembly;
a cell case having a housing space housing the electrode assembly and a through hole communicating with the housing space and an outside of the cell case;
a sealing member; and
the sealing member cap according to claim 1.

13. A method of producing an electric storage device, the electric storage device including:
a cell case having a through hole;
a sealing member inserted in the through hole and sealing the through hole; and
a sealing member cap having a column shape and including an insertion portion having a recess therein, the insertion portion including a body section and a large cross-section section, the recess being larger in cross-sectional area in a plane perpendicular to an axial direction of the insertion portion at the large cross-section section than at the body section,
the method comprising:
inserting the insertion portion into the through hole such that the body section is positioned in the through hole and the large cross-section section is positioned inside the cell case, whereby the through hole is temporary sealed;
inserting the sealing member into the recess of the insertion portion after the through hole is temporary sealed; and
deforming the sealing member to seal the through hole.
